(19) United States
(12) Patent Application Publication
(10) Pub. No.: US 2019/0334152 A1
(43) Pub. Date: Oct. 31, 2019

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroshi SHIMIZU, Mie (JP); Ryouya OKAMOTO, Mie (JP); Hitoshi TAKEDA, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 16/462,007

(22) PCT Filed: Nov. 10, 2017
(86) PCT No.: PCT/JP2017/040536

§ 371 Date: May 17, 2019

(30) Foreign Application Priority Data
Nov. 28, 2016 (JP) 2016-230512

(51) Int. Cl. H01M 2/20; H01M 2/10; H01M 10/42; H01R 13/73

(52) U.S. Cl. CPC H01M 2/202; H01R 13/73; H01M 10/42; H01M 2/1077

(57) ABSTRACT

A wiring module is for attachment to a power module in which power elements that store or generate electrical power are arranged side-by-side. The wiring module includes: an insulating protector that houses interconnection conductors for interconnecting the power elements; detection wires that are housed in the insulating protector, extend from a side corresponding to the power elements, and detect a state of the power elements; a connector that is provided at an end portion of the detection wires and is arranged inside the insulating protector; an electrical wire housing portion that is provided in the insulating protector and houses the detection wires; and a connector support portion that includes a fixing portion for fixing a housing of the connector to the insulating protector.

### TECHNICAL FIELD

The present invention relates to a wiring module for interconnecting cells or the like.

### BACKGROUND ART

Patent Document 1 discloses a known example of a wiring module for arrangement on a storage battery.

Such a wiring module generally includes detection wires for detecting the statuses of electric cells included in the storage battery, and a connector is provided at the leading ends of the detection wires to enable connection to a connector (hereinafter, called a “partner connector”) that is provided in a partner device such as an ECU (Electronic Control Unit). Because this connector is a power supply connector, it is common knowledge to employ a female connector in order to prevent contact with a hand.

In the case of the wiring module in Patent Document 1 indicated below, the detection wires extend from one end side of a main body of the wiring module to the outside and bundled such that the leading end portions thereof can be pointed in any direction, and then a female connector is provided at the leading end portions (so-called pigtail).

Note that after the operation for connecting the connector to a partner connector is complete, the connector needs to be fixed by some sort of means in order to avoid the case of becoming damaged due to coming into contact with another component due to vibration during vehicle traveling, for example. However, the wiring module in Patent Document 1 employs a pigtail, and therefore cannot be fixed to the wiring module itself. For this reason, in order to fix the wiring module in Patent Document 1, it is necessary to rely on a fixing means provided in the external structure of a partner device or the like. Also, in the case of a pigtail as well, space is required for extension of the detection wires from the one end side of the main body of the wiring module, and moreover, a protection member for protecting the detection wires from the outside needs to be provided extending from the interior of the wiring module to the interior of the female connector at the leading ends of the detection wires, thus leading to the problem of poor workability during assembly.

### CITATION LIST

### Patent Document

Patent Document 1; JP 2016-9646A ([0036], FIG. 1)

### SUMMARY OF INVENTION

### Technical Problem

The present invention was achieved in light of the foregoing circumstances, and an object of the present invention is to provide a wiring module that enables a connector for detection wires to be fixed to itself.

### Solution to Problem

A wiring module according to technology disclosed in the present specification is a wiring module for attachment to a power module in which a plurality of power elements that store or generate electrical power are arranged side-by-side, the wiring module including: an insulating protector that houses a plurality of interconnection conductors for interconnecting the power elements; a plurality of detection wires that are housed in the insulating protector, extend from a side corresponding to the power elements, and detect a state of the power elements; a connector that is provided at an end portion of the detection wires and is arranged inside the insulating protector; an electrical wire housing portion that is provided in the insulating protector and houses the detection wires; and a connector support portion that includes a fixing portion for fixing a housing of the connector to the insulating protector.

According to this configuration, the connector on the power supply side can be fixed in the wiring module, thus making it possible to eliminate the need for a fixing means on the partner connector side. Also, the connector is connected to detection wires inside the wiring module, and therefore a pigtail is not necessary, workability is improved during assembly of the wiring module, and overall space efficiency is achieved.

Configurations described below are preferable as embodiments of the wiring module disclosed in the present specification.

The connector includes a male terminal, the housing of the connector includes a hood portion for being fitted around a partner housing, and the connector support portion includes a touch prevention lid for blocking an opening portion of the hood portion.

In the case of employing a male terminal on the power supply side, voltage is applied to a terminal that can be easily touched from the outside, but according to the above configuration, the opening portion of the connector is blocked so as to shield the terminal from the outside, thus making it possible to prevent touching of the terminal while the partner connector has not been mated.

The touch prevention lid is integrated with the insulating protector via a hinge.

According to this configuration, even when the male connector is mated to the partner connector, and the touch prevention lid is detached, there is no risk of loss of the touch prevention lid, and when the partner connector is removed from the male connector, the opening portion of the hood portion of the male connector can be swiftly closed, thus making it possible to reliably achieve touch prevention.

The fixing portion of the connector is provided on one end side of the insulating protector with respect to an arrangement direction of the plurality of power elements, and the hood portion is open in a direction orthogonal to the arrangement direction of the plurality of power elements.

Although it difficult to reduce the size of the power module in the arrangement direction of the power elements, according to the above configuration, the partner connector is mated to the connector in a direction orthogonal to the arrangement direction of the power elements, and therefore there is no need to further provide space for mating with the partner connector on the one end side in the arrangement direction of the power elements, and it is possible to commensurately achieve space efficiency in the arrangement direction of the power elements.

A plurality of the housings of the connectors are stacked.

When the number of power elements that constitute the power module increases, the number of terminals in the housing increases by the same amount, and therefore the size of the housing in the arrangement direction of the power elements also increases, thus resulting in an increase in the amount of space that is used in the arrangement direction of the power elements. However, according to the above configuration, the increase in the number of terminals can be accommodated by stacking multiple housings, thus making it possible to suppress an increase in the amount of used space in the arrangement direction of the power elements.

### Advantageous Effects of Invention

A wiring module according to technology disclosed in the present specification enables a connector for detection wires to be fixed to itself.

### BRIEF DESCRIPTION OF DRAWINGS

FIG. 1 is a perspective view of a wiring module of a first embodiment.

FIG. 2 is a top view of the wiring module.

FIG. 3 is a perspective view of an insulating protector.

FIG. 4 is a perspective view of a connector housing portion.

FIG. 5 is a front view of a male connector.

FIG. 6 is a bottom view of the male connector.

FIG. 7 is a front view of the connector housing portion to which the male connector is fixed.

FIG. 8 is a partial cutout perspective view of the connector housing portion to which the male connector is fixed.

FIG. 9 is a cross-sectional view taken along A-A in FIG. 7.

FIG. 10 is a perspective view of a state where a connector cover and a touch prevention lid have been placed on the male connector in the fixed state.

FIG. 11 is a cross-sectional perspective view of FIG. 10.

FIG. 12 is a perspective view of a state where the male connector and a partner connector have been mated.

FIG. 13 is a front view of the wiring module of the second embodiment.

FIG. 14 is a front view of a wiring module of a third embodiment.

### DESCRIPTION OF EMBODIMENTS

### First Embodiment

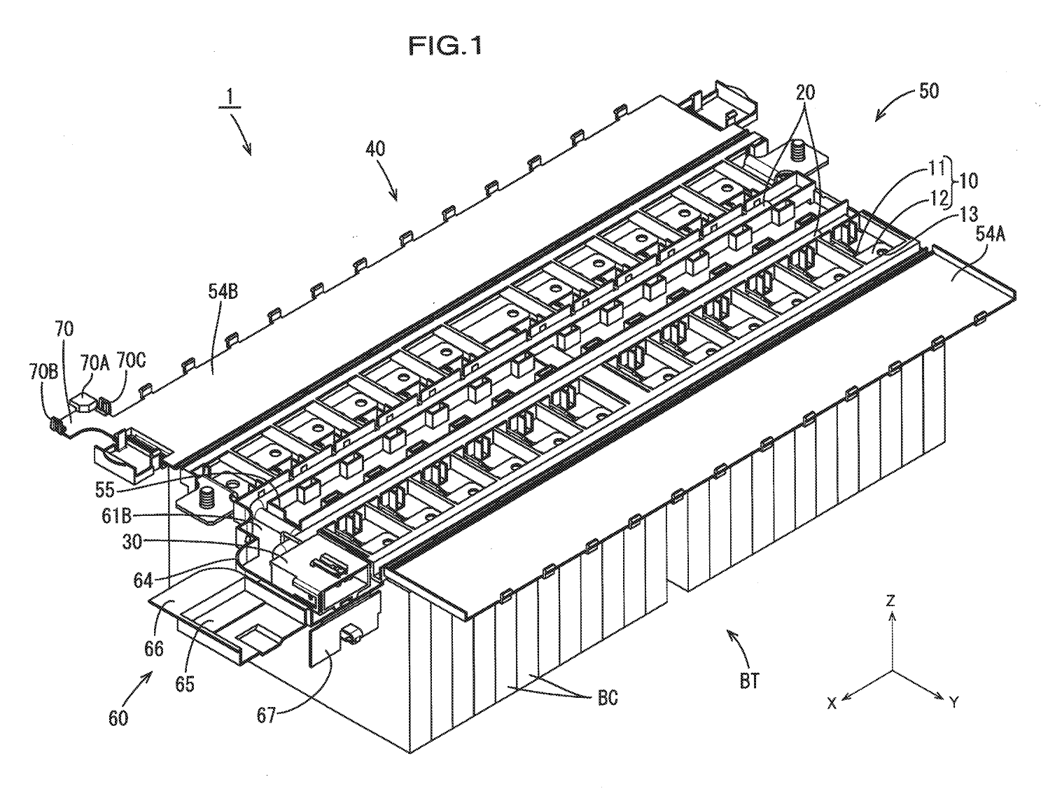

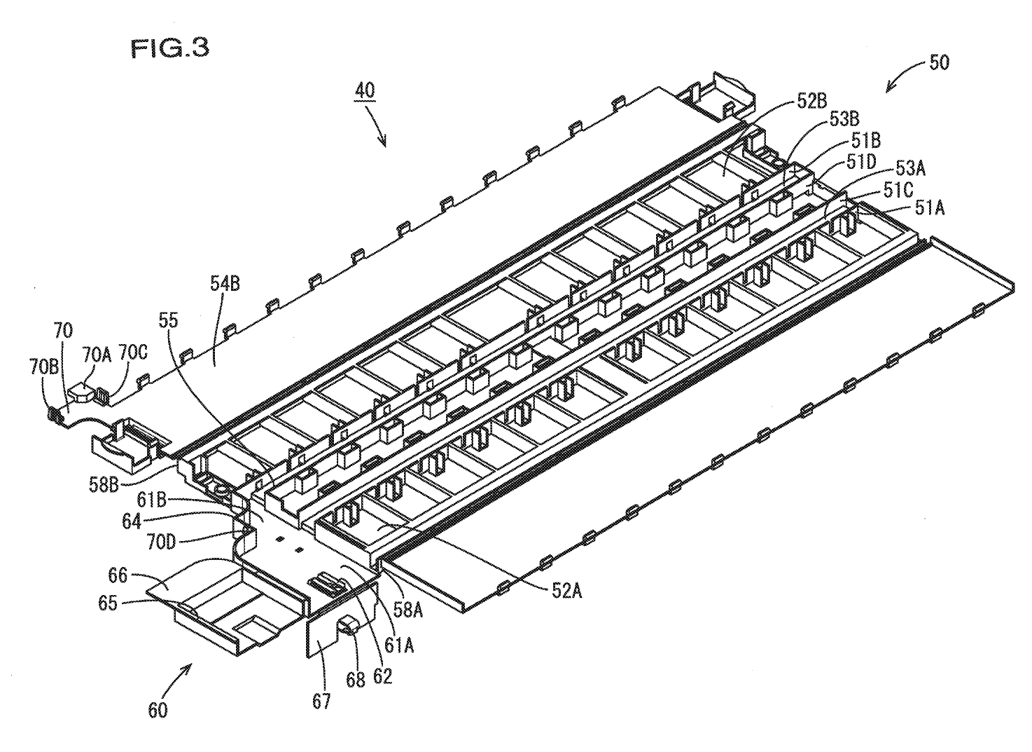

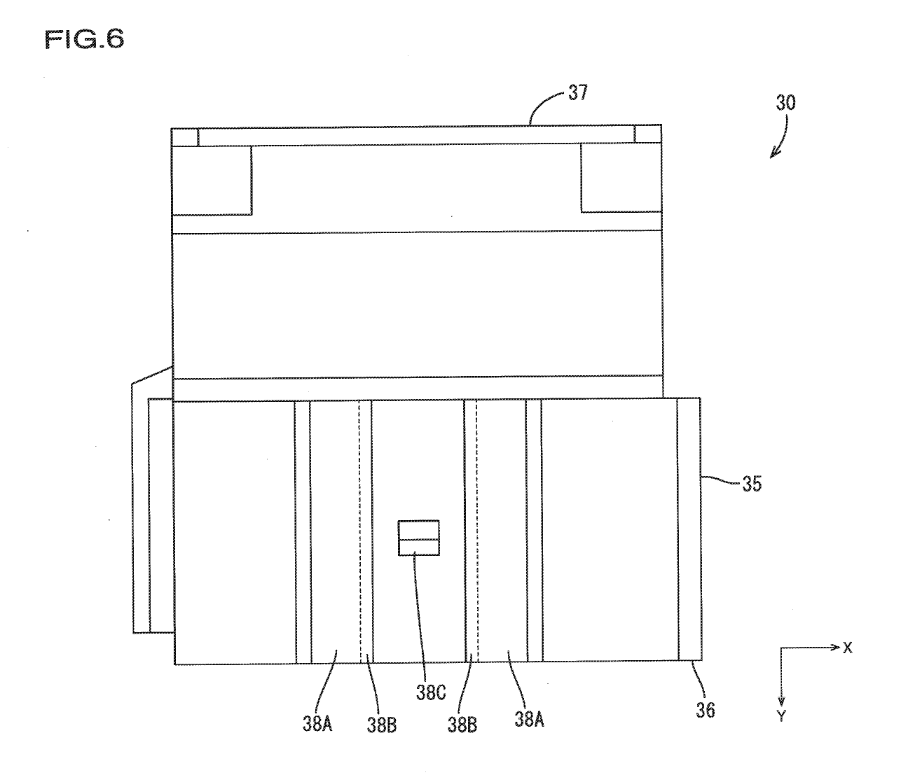

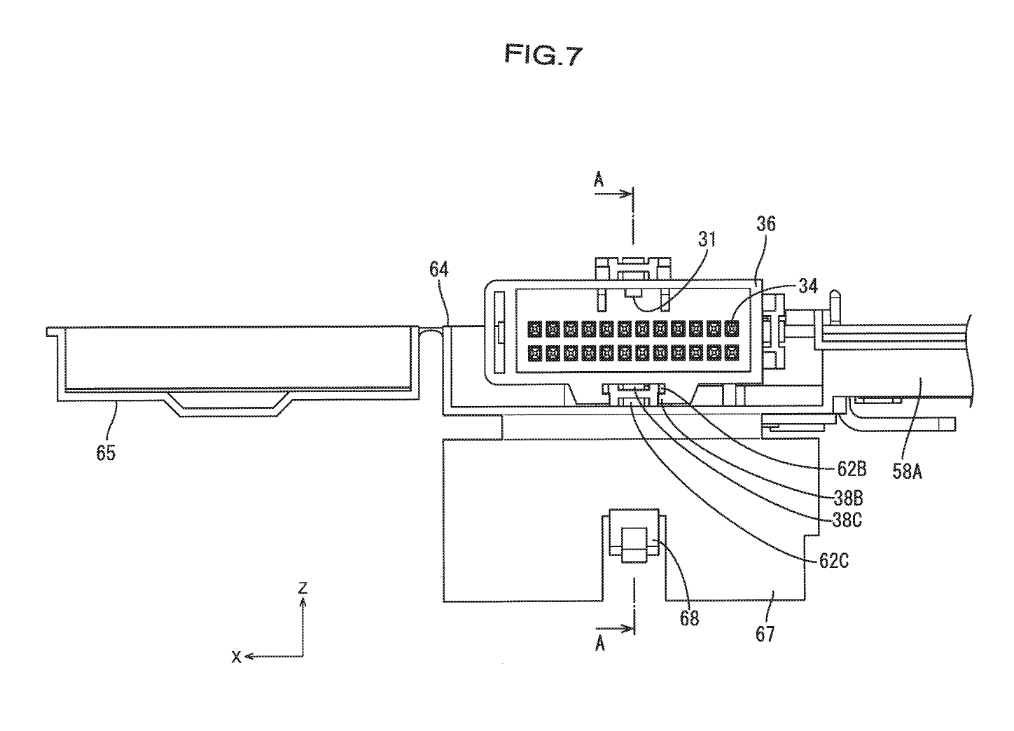

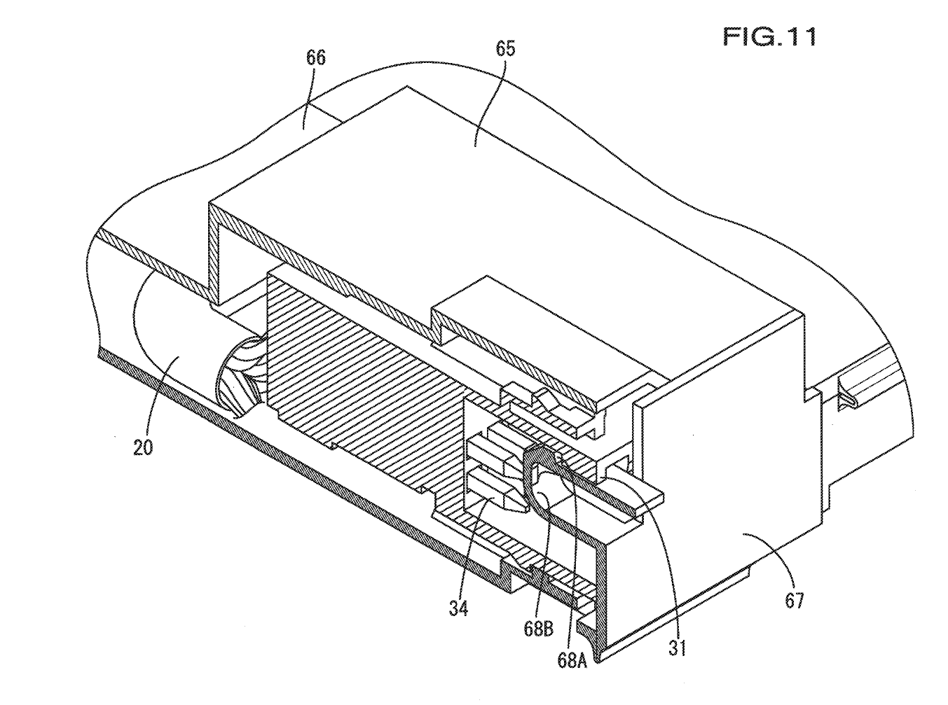

A first embodiment of technology disclosed in the present specification will be described below with reference to FIGS. 1 to 13.

A wiring module 1 of the present embodiment is for mounting to a power storage module in which a plurality of power storage elements, which may be lithium ion batteries or the like, are arranged side-by-side. A power storage module BT is for installation in a vehicle such as an electric automobile or a hybrid automobile, and is used as a power supply for traveling. In the following description, the X direction in the drawings is the rightward direction, the Y direction is the forward direction, and the Z direction is the upward direction. Also, in the following description, when there are more than one of the same member, there are cases where only one of such members is denoted by a reference sign, and reference signs have been omitted for the other members.

The power storage module BT (one example of a “power module”) includes a plurality of power storage elements BC that are arranged side-by-side in a single line in the X axis direction, and the wiring module 1 is attached to the upper surface, as shown in FIG. 1. The power storage elements BC each have a flattened rectangular parallelepiped-shaped main body portion in which a power storage element is housed, and include a bolt-shaped electrode terminal (not shown) that projects from a seat portion 61 provided on an upper portion of the main body portion. Note that the power storage elements BC are one example of power elements, and may also be a battery, a capacitor, or a fuel cell.

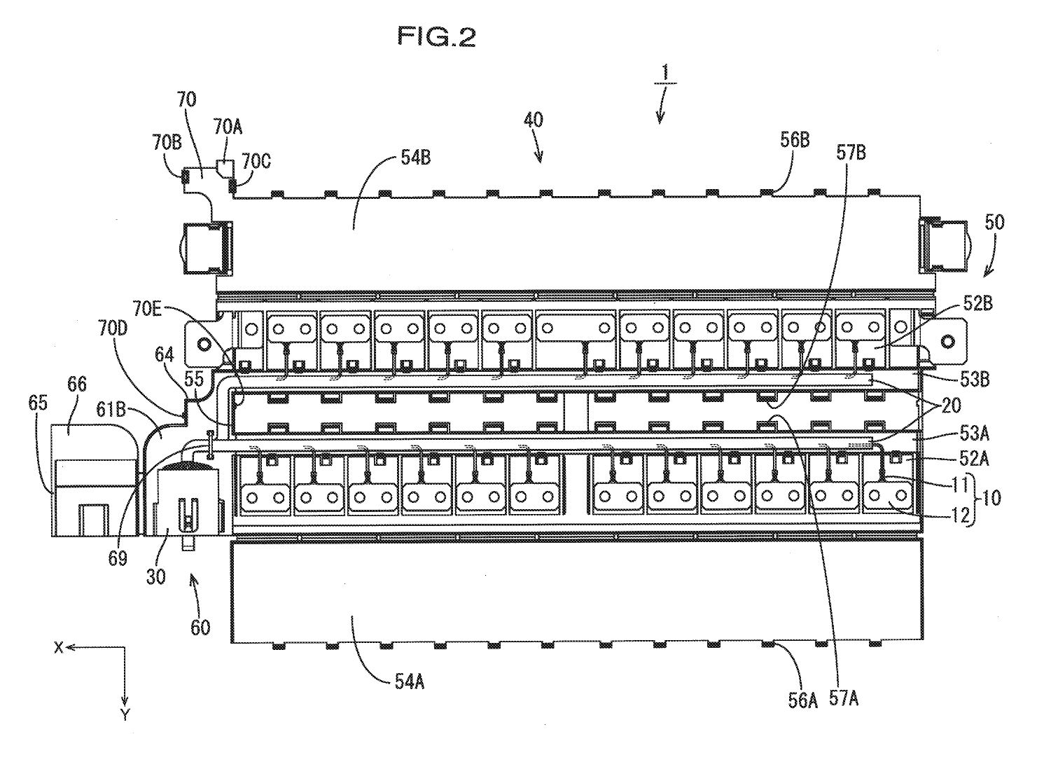

As shown in FIGS. 1 and 2, the wiring module 1 is configured by a plurality of bus bar terminals 10 (one example of a circuit), a plurality of detection wires 20 that are respectively connected to the bus bar terminals 10, a male connector 30 that is connected to the ends of the detection wires 20, and an insulating protector 40 that houses the above-mentioned members and is placed on the upper surface of the power storage module BT.

The bus bar terminals 10 correspond to interconnection conductors that are formed from a conductive metal plate made of copper, a copper alloy, aluminum, an aluminum alloy, or the like, and each include a terminal connection portion 12 that is connected to an electrode terminal BP of a corresponding power storage element BC, and a wire connection portion 11 that is integrated with the terminal connection portion 12.

Each of the terminal connection portions 12 is shaped as a substantially rectangular plate, and is provided with a bolt through-hole 13 in each of two end portions in the lengthwise direction for connecting the power storage elements BC to each other. The electrode terminals BP of the power storage elements BC can be passed through the bolt through-holes 13.

Each of the wire connection portions 11 is constituted by a pair of crimping pieces, and is connected to one end portion of a corresponding detection wire 20 by being fixed thereto through crimping. The other end portion of the detection wire 20 is connected to a terminal fitting (not shown) of the later-described male connector 30. The detection wire 20 is an insulated electrical wire including a conductor portion that is surrounded by an insulation covering (insulating layer). The detection wire 20 and the male connector 30 are for connecting the bus bar terminal 10 to an external ECU (Electronic Control Unit) that is not shown. Note that the ECU is provided with a microcomputer, electronic components, and the like, and has a known configuration including functions for detecting the voltage, current, temperature, and the like of the power storage elements BC, controlling the charging and discharging of the power storage elements BC, and so on.

The insulating protector 40 is made of an insulating synthetic resin, and as shown in FIGS. 1 to 3, includes a bus bar support portion 50 that supports the bus bar terminals 10, and a connector housing portion 60 that is integrated with the bus bar support portion 50 so as to be continuous therewith from the right end portion thereof.

The bus bar support portion 50 has a substantially rectangular plate surface and is provided with a front wall portion 58A and a rear wall portion 58B at the front and rear edge portions of the substantially rectangular plate surface, and first to fourth partition walls 51A to 51D are provided extending in the left-right direction between the front wall portion 58A and the rear wall portion 58B. The right end edge portions of the third partition wall 51C and the fourth partition wall 51D are joined to a partition joining portion 55 that is provided extending upward from the plate surface of the bus bar support portion 50.

One portion of the plate surface of the bus bar support portion 50 between the front wall portion 58A and the first partition wall 51A is a first bus bar mounting surface 52A, and another portion of the plate surface between the rear wall portion 58B and the second partition wall 51B is a second bus bar mounting surface 52B. The bus bar mounting surfaces 52A and 52B are divided by dividing walls into small sections that are side-by-side in the left-right direction, and two through-holes (not shown) are provided in each of the small sections. As shown in FIG. 1, the bus bar terminals 10 are mounted on the bus bar mounting surfaces 52A and 52B in the small sections in an orientation according to which two threaded holes are side-by-side in the left-right direction (arrangement direction of the power storage elements BC). Note that in each of the small sections, a cutout is provided in the upper edge portion of the first partition wall 51A or the second partition wall 51B.

One portion of the plate surface of the bus bar support portion 50 between the first partition wall 51A and the third partition wall 51C is a first wire mounting surface 53A, and another portion of the plate surface between the second partition wall 51B and the fourth partition wall 51D is a second wire mounting surface 53B.

The detection wires 20 connected to the bus bar terminals 10 extend over the bus bar mounting surfaces 52A and 52B, pass through the cutouts in the first partition wall 51A and the second partition wall 51B, are routed along the wire mounting surfaces 53A and 53B, and are then drawn out from the right end portions thereof. Note that the individual detection wires 20 are not shown in detail in the wire mounting portions and the connector housing portion 60, but rather are shown schematically by one tube-shaped member in each routing location.

A flat plate-shaped first cover 54A and second cover 54B are respectively integrated with the upper edge portions of a front wall portion and a rear wall portion of the bus bar support portion 50 via hinges. The end edge portions of the first cover 54A and the second cover 54B on the side opposite to the hinges are respectively provided with locking claws 56A and 56B that are spaced apart at equal intervals. The surface of the third partition wall 51C that is on the side distant from the front wall portion 58A and the surface of the fourth partition wall 51D that is on the side distant from the rear wall portion 58B are respectively provided with lock receiving portions 57A and 57B that are spaced apart at equal intervals and correspond to the locking claws 56A and 56B. Accordingly, when the covers are closed by being pivoted at the hinges so as to cover the tops of the bus bar mounting surfaces 52A and 52B and the wire mounting surfaces 53A and 53B, the locking claws 56A and 56B of the covers become locked to the lock receiving portions 57A and 57B.

As shown in FIGS. 2 to 4, the connector housing portion 60 (one example of a connector support portion and an electrical wire housing portion) is provided on the right end side of the insulating protector 40 in the arrangement direction of the power storage elements BC, and includes a plate-shaped seat portion 61, a connector locking portion 62 (one example of a fixing portion) provided on the seat portion 61, a side wall portion 64, a connector cover 65, a front wire cover 66, a rear wire cover 70, and a touch prevention lid 67.

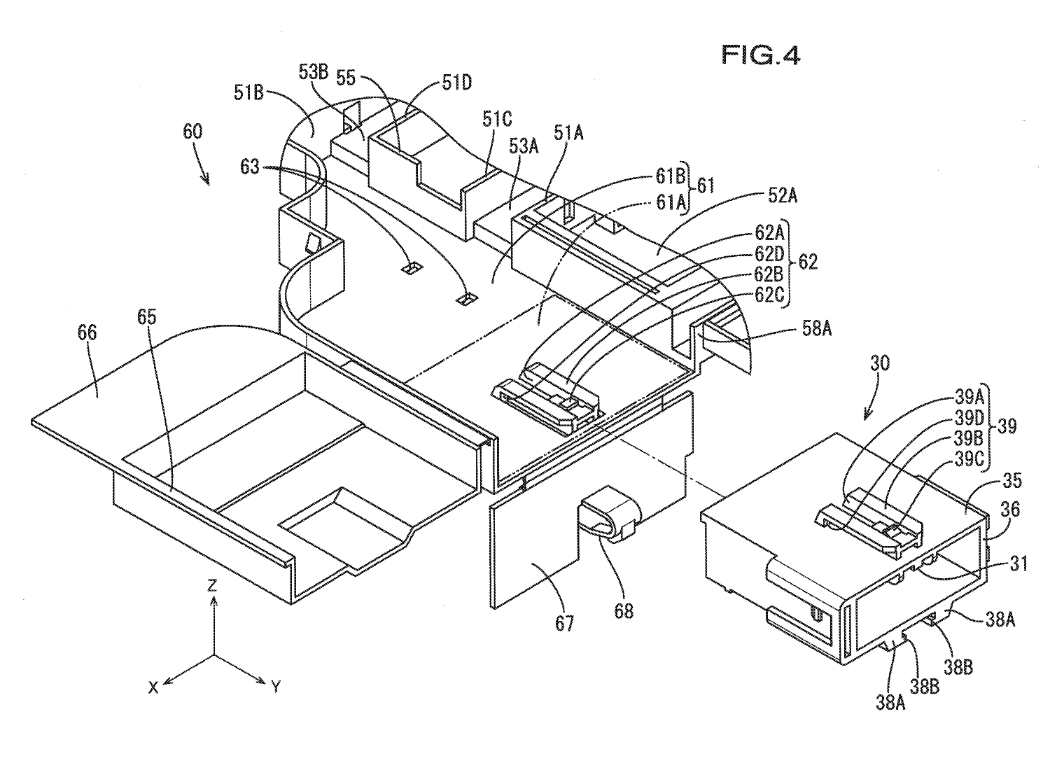

As shown in FIG. 4, the seat portion 61 is shaped as a plate provided extending rightward from the plate surface of the bus bar support portion 50 while having somewhat of a step, and as shown by dashed double-dotted lines in FIG. 4, includes a rectangular connector support surface 61A provided to the right of the first bus bar mounting surface 52A, and a joining surface 61B (one example of an electrical wire housing portion) that joins the right end portions of the first wire mounting surface 53A and the second wire mounting surface 53B to the rear end portion of the connector support surface 61A. Note that the second partition wall 51B of the connector support portion extends rightward of the right end portion of the second wire mounting surface 53B, and the lower edge is joined to the rear end edge of the joining surface 61B. The width and length of the connector support surface 61A are set such that the connector can be placed thereon. The joining surface 61B is provided with a pair of fixing member insertion holes 63 for fixing the detection wires 20.

The connector locking portion 62 is one example of a fixing portion, has a left-right symmetric shape, and includes a pair of elongated plate-shaped rail portions 62A that extend from approximately the central portion of the connector support surface 61A to the vicinity of the front end edge portion, elongated plate-shaped head portions 62B that protrude outward in the width direction from the upper surfaces of the rail portions 62A, abutting portions 62D that join the rear end edge portions of the head portions 62B to the connector support surface 61A, and a step portion 62C that rises up with a step-like shape while extending forward from approximately the center in the front-rear direction between the two rail portions 62A. The highest upper surface of the step portion 62C is set to a height not protruding upward from the upper surfaces of the head portions 62B. Note that the connector locking portion 62 is provided with a sharp-cornered “U” shaped slit with portions of the rear end edge portion remaining, and therefore the connector locking portion 62 has a cantilevered shape capable of undergoing elastic deformation in the up-down direction with the rear end edge portion serving as the base portion.

The side wall portion 64 is provided rising from the right edge portion of the seat portion 61 and has a height that is approximately half the height of the male connector 30. The rear end edge portion of the side wall portion 64 is continuous with the right end edge portion of the second partition wall 51B of the connector support portion.

The connector cover 65 is integrated with the upper end edge portion of a straight portion of the side wall portion 64 that rises from the connector support surface 61A, and is capable of pivoting via a hinge. A recessed portion having a depth that is approximately half the height of the male connector 30 is provided on the inner side of the connector cover 65 (the upper surface side in FIG. 4), and the bottom surface of the recessed portion is provided with an appropriate depression that conforms to the upper surface shape of the male connector 30.

The rear end edge portion of the connector cover 65 extends rearward with a flat plate shape, thus forming the front wire cover that covers the front half of the joining surface 61B. Also, as shown in FIGS. 1 to 3, the right-rear corner portion of the second cover 54B provided in the bus bar support portion 50 extends diagonally rightward and rearward, thus forming the rear wire cover 70 that covers the rear half of the joining surface 61B. The rear wire cover 70 is provided with side pieces 70B and 70C on the left and right end portions that project upward in the state shown in FIGS. 1 to 3, and a bearing piece 70A is provided projecting rearward from the upper surface of the rear end portion.

The touch prevention lid 67 is provided on the front end edge portion of the connector support surface 61A and can pivot via a hinge. The width of the touch prevention lid 67 is set approximately the same as the width of the connector support surface 61A. A cutout is provided at the center of the end edge portion of the touch prevention lid 67 on the side opposite to the hinge, and a tab piece 68 is provided so as to pass through the cutout.

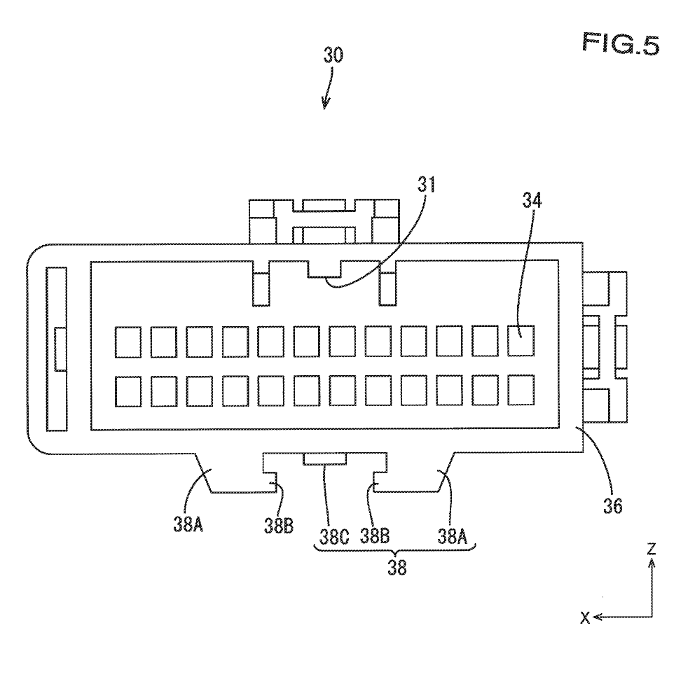

As shown in FIGS. 4 to 8, the male connector 30 includes a flattened rectangular parallelepiped-shaped housing and male terminals 34. The housing is provided with an opening face 36 (one example of an “opening portion”) that is open in the front direction (i.e., a direction orthogonal to the arrangement direction of the power storage elements BC), thus forming a hood portion 35 that is to be fitted around a partner connector F, and the male terminals 34 project forward from a deep portion of the hood portion 35. As shown in FIG. 5, a mooring projection 31 projects downward from the center of the lower surface of a top plate portion of an opening edge portion of the hood portion 35.

A locking leg portion 38 are provided on the lower surface of a bottom plate portion of the hood portion 35. The locking leg portion 38 has a shape that symmetric about a center line in the left-right direction of the lower surface of the bottom plate portion, and includes a projection portion 38C that projects from approximately the central portion of the lower surface of the bottom plate portion, and a pair of leg portions 38A that project downward in a range from the front end of the hood portion 35 to the rear end. The lower surface in approximately the rear half portion of the projection portion 38C is a tapered surface that is inclined such that the front side is lower than the rear side. Lower surface portions of the leg portions 38A protrude so as to face each other over the entire length in the front-rear direction, thus forming a pair of clamp portions 38B. End portions of the detection wires 20 extending from the bus bar support portion 50 are introduced to a back surface 37 of the male connector 30.

A joining portion 39 is provided on the top plate portion of the hood portion 35. The joining portion 39 is one example of a fixing portion, and as will be described later, is used when stacking another male connector 30 onto the male connector 30. The joining portion 39 has a left-right symmetric shape, and includes a pair of elongated plate-shaped rail portions 39A that extend from approximately the central portion of the upper surface of the top plate portion to the vicinity of the front end edge portion, elongated plate-shaped head portions 39B that protrude outward in the width direction from the upper surfaces of the rail portions 39A, abutting portions 39D that join the rear end edge portions of the head portions 39B to the upper surface of the top plate portion, and a step portion 39C that rises up with a step-like shape while extending forward from approximately the center in the front-rear direction between the two rail portions 39A. The highest upper surface of the step portion 39C is set to a height not protruding upward from the upper surfaces of the head portions 39B, and the front face is a tapered surface having a height that decreases while extending forward. Note that the joining portion 39 is arranged such that the front surfaces of the abutting portions 39D and the rear end surfaces of the previously described leg portions 38A are overlapped in a skeleton view of the upper surface of the hood portion 35.

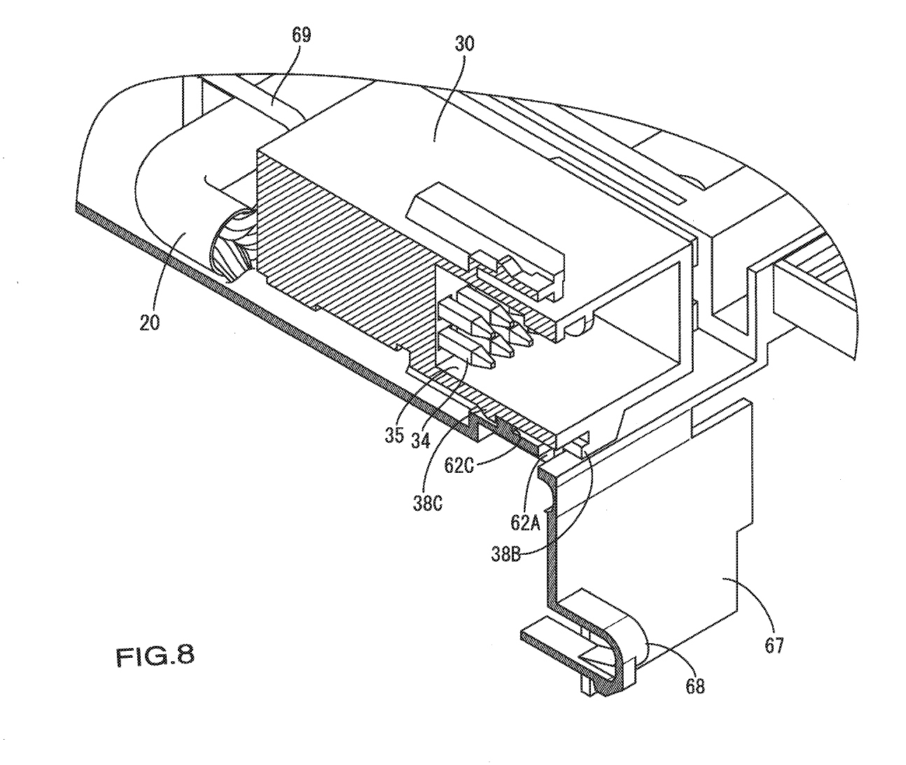

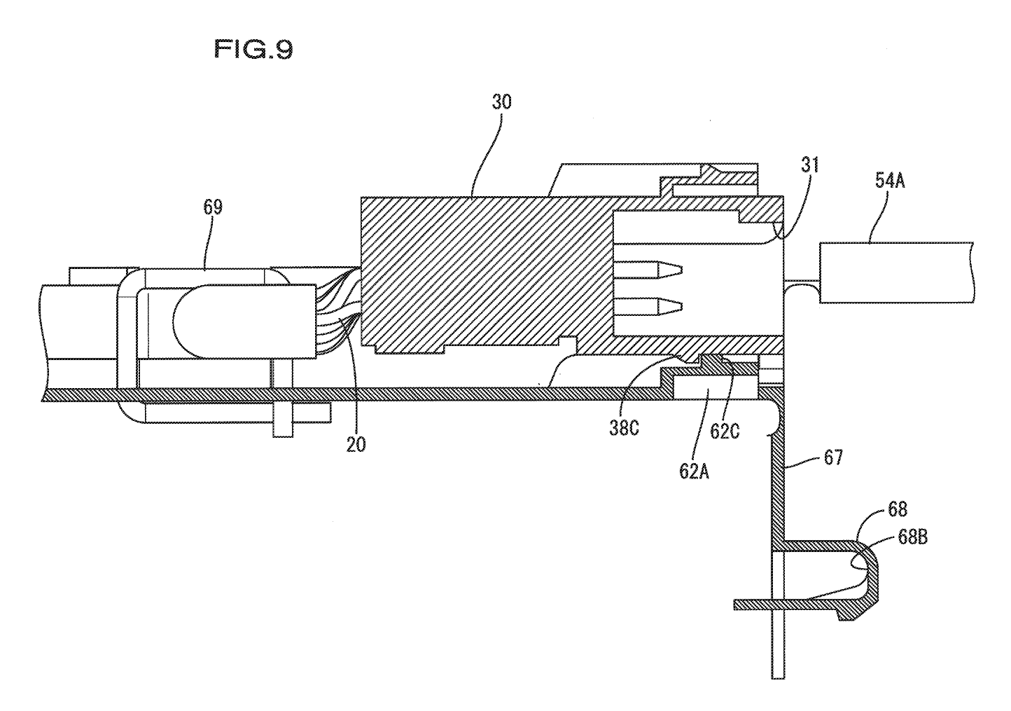

As shown in FIG. 4, in order to house the male connector 30 in the connector housing portion 60, the back surface 37 of the male connector 30 is directed toward the connector housing portion, and the male connector 30 is moved rearward with the upper surfaces of the two clamp portions 38B of the leg portions 38A sliding on the lower surfaces of the two head portions 62B of the connector locking portion 62. At this time, the connector locking portion 62 is capable of being elastically displaced in the up-down direction with the rear end portion serving as the base, and therefore if the male connector 30 is moved while slightly lifting the side thereof that is provided with the opening face 36 (the rear side in the advancing direction), the male connector 30 can be moved smoothly while avoiding interference with the connector support surface 61A. The tapered surface of the projection portion 38C of the male connector 30 moves over the upper surface of the step portion 62C of the connector locking portion 62 while causing it to be elastically displaced downward, and after moving beyond the uppermost surface, as shown in FIGS. 8 and 9, the step portion 62C undergoes elastic restoration, and the back surface thereof rises up in front of the front face of the projection portion 38C. At this time, the back surfaces of the two leg portions 38A face the abutting portions 62D of the connector locking portion 62 with a small clearance of separation therebetween, thus restricting rearward displacement. In this way, the two leg portions 38A of the male connector 30 are locked to the connector locking portion 62 of the connector housing portion 60, and the male connector 30 is thus fixed to the insulating protector 40.

As shown in FIGS. 1 and 2, the detection wires 20, which extend from the second wire mounting surface 53B and enter the connector housing portion 60, bend forward at an approximately right angle on the joining surface 61B, extend to an extension line of the first wire mounting surface 53A, then bend rightward at an approximately right angle, and merge with detection wires 20 that extend from the first wire mounting surface 53A into the connector housing portion 60. The fixing member 69 is placed over the merged group of detection wires 20, and the detection wires 20 are inserted into an insertion hole of the seat portion 61 so as to be fixed to the joining surface 61B, and then the detection wires 20 are further bent at an approximately right angle between the joining surface 61B and the back surface 37 of the male connector 30. Note that although the example of a sharp-cornered “U” shaped fixing member 69 is shown in the present embodiment, the fixing member 69 may be a cable tie, or in other words, it is sufficient to be able to fix the detection wires 20 inside the connector housing portion 60.

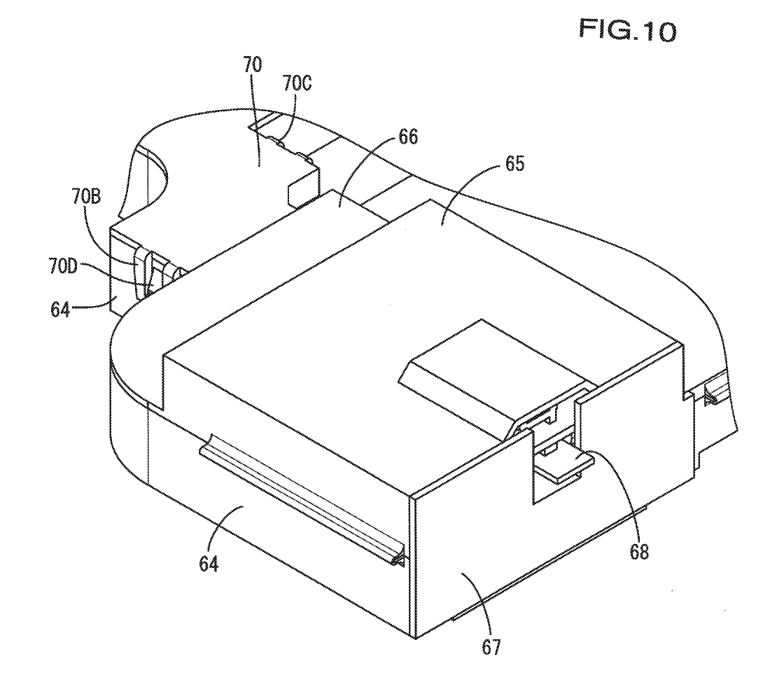

As shown in FIG. 10, the connector cover 65 is placed over the upper surface of the male connector 30 that is locked to the locking portion 62, and therefore the male connector 30 is covered, and the front half of the detection wires 20 arranged on the joining surface 61B is covered by the front wire cover 66. Note that the rear half of the detection wires 20 arranged on the joining surface 61B is covered by the rear wire cover 70 that is integrated with the second cover 54B when the second cover 54B is placed over the connector support portion. At this time, the two side pieces 70B and 70C of the rear wire cover 70 are locked with lateral claws 70D and 70E that are respectively provided on the side wall portion 64 of the connector housing portion 60 and the partition joining portion 55, and the bearing piece 70C of the rear wire cover 70 is inserted below the front wire cover 66, and therefore the rear wire cover 70 is supported by the side wall portion 64 and the partition joining portion 55, and the front wire cover 66 and the connector cover 65 integrated therewith are supported by the bearing piece 70C of the rear wire cover 70. Accordingly, the detection wires 20 on the joining surface 61B are protected from external force applied from above.

Also, as shown in FIG. 10, the touch prevention lid 67 provided in the connector support portion is placed over the opening face 36 of the male connector 30. Note that when placed over the opening of the male connector 30, the tab piece 68 of the touch prevention lid 67 extends from the bottom side of the cutout toward the interior space of the male connector 30, then bends back in a U shape from a bent-back portion 68B at a location in front of the leading ends of the male terminals 34, and then extends outward beyond the plate surface of the touch prevention lid 67. A locking projection 68A is provided on the upper surface of the bent-back portion, and when the locking projection 68A is pushed rearward of a projection portion provided on the lower surface of the top plate of the hood portion 35 of the male connector 30, the touch prevention lid 67 is prevented from opening.

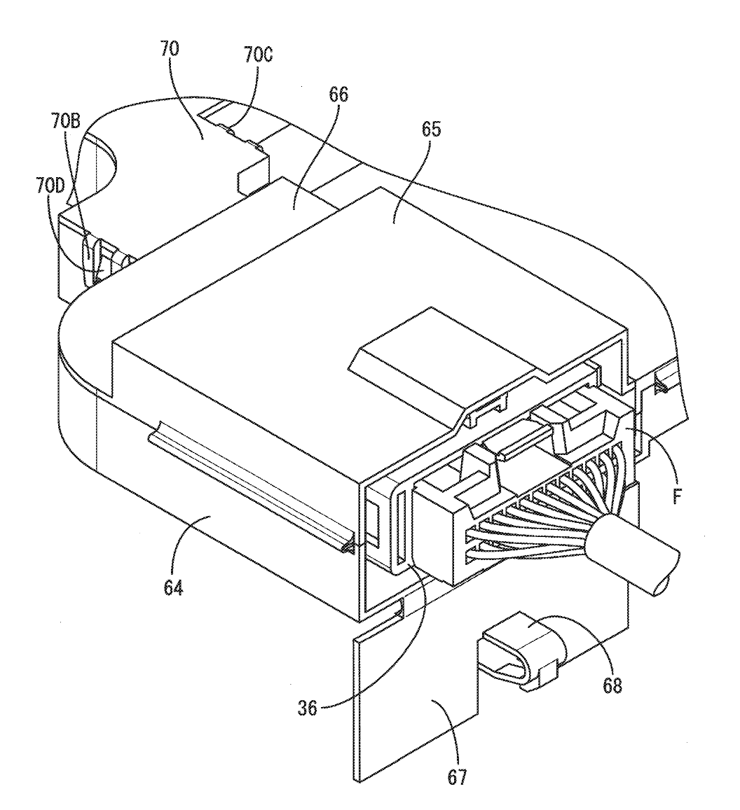

When the partner connector F is to be mated to the male connector 30, the outward extending portion of the tab piece 68 of the touch prevention lid 67 is pushed downward and undergoes elastic deformation so as to cancel the opening prevention, and as shown in FIG. 12, the touch prevention lid 67 is opened to free the opening face 36 of the male connector 30, and the partner connector F is fitted into the hood portion 35 of the male connector 30.

According to the configuration of the present embodiment, the connector on the power storage module side can be fixed inside the wiring module 1, thus eliminating the need to rely on a fixing means provided in an external means such as the partner connector F, and the connector can be reliably fixed. Also, the front wire cover 66 is integrated with the connector cover 65, and the rear wire cover 70 is integrated with the second cover 54B, and therefore the detection wires 20 housed in the connector housing portion 60 can be protected by merely being covered by the connector cover 65 and the second cover 54B, thus achieving excellent workability when assembling the wiring module 1.

Also, the partner connector F is mated with the connector on the wiring module 1 side in a direction orthogonal to the arrangement direction of the power storage elements BC, thus eliminating the need to provide mating space in the arrangement direction of the power storage elements BC, and making it possible to commensurately improve space efficiency in the arrangement direction of the power storage elements BC.

Furthermore, although the male connector 30 is employed as the power supply connector in the present embodiment, the touch prevention lid 67 is provided so as to cover the opening face 36 of the male connector 30, and the bent-back portion 68B of the tab piece 68 is interposed between the male terminals and the outside in the cutout portion of the touch prevention lid 67, and therefore even when the wiring module 1 is attached to the power storage module BT and voltage is applied to the male terminals 34, there is no risk of a worker mistakenly putting a finger inside the opening of the male connector 30 and touching a male terminal 34. Also, the touch prevention lid 67 can be easily opened and closed at any time by merely pushing down the tab piece with one hand, thus making it possible to keep the touch prevention lid 67 closed until immediately before mating with the partner connector F, and making it possible to more reliably achieve touch prevention.

Also, the touch prevention lid 67 is joined to the insulating protector 40 via a hinge, and therefore there is no risk of becoming lost while the partner connector F is mated to the male connector 30 (while the touch prevention lid 67 is not being used), and when the partner connector F is removed for maintenance or the like, the touch prevention lid 67 can be reapplied to block the opening face 36 of the male connector 30, thus making it possible to more reliably achieve touch prevention.

### Second Embodiment

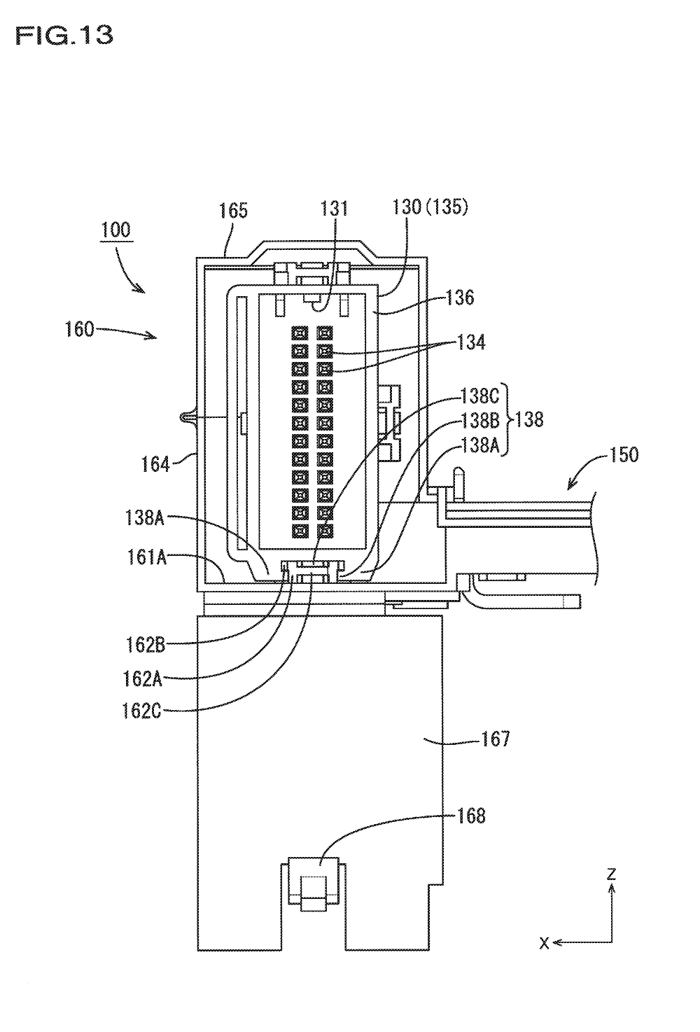

A second embodiment of technology disclosed in the present specification will be described below with reference to FIG. 13.

Whereas the wiring module 1 of the first embodiment has a configuration in which the male connector 30 is housed in a state where the wider surfaces (top plate and bottom plate) are oriented parallel with the connector support surface 61A, a wiring module 100 of the present embodiment has a configuration in which a male connector 130 is housed in a connector housing portion 160 in a state where the wider surfaces (top plate and bottom plate) are oriented perpendicular to the connector support surface 61A. In this case, a mooring projection 131 is provided at the center of an opening edge portion of one side surface portion of the hood portion 135 that connects the top plate and the bottom plate, and a pair of locking leg portions 138 are provided on the side surface portion that is on the opposite side. Other configurations are similar to the first embodiment, and descriptions will not be given for them.

According to the present embodiment, the male connector 30 is housed in the wiring module 1 in an erect state, thus making it possible to shorten the length of the connector support portion in the arrangement direction of the power storage element BC while also guaranteeing effects similar to those of the first embodiment.

### Third Embodiment

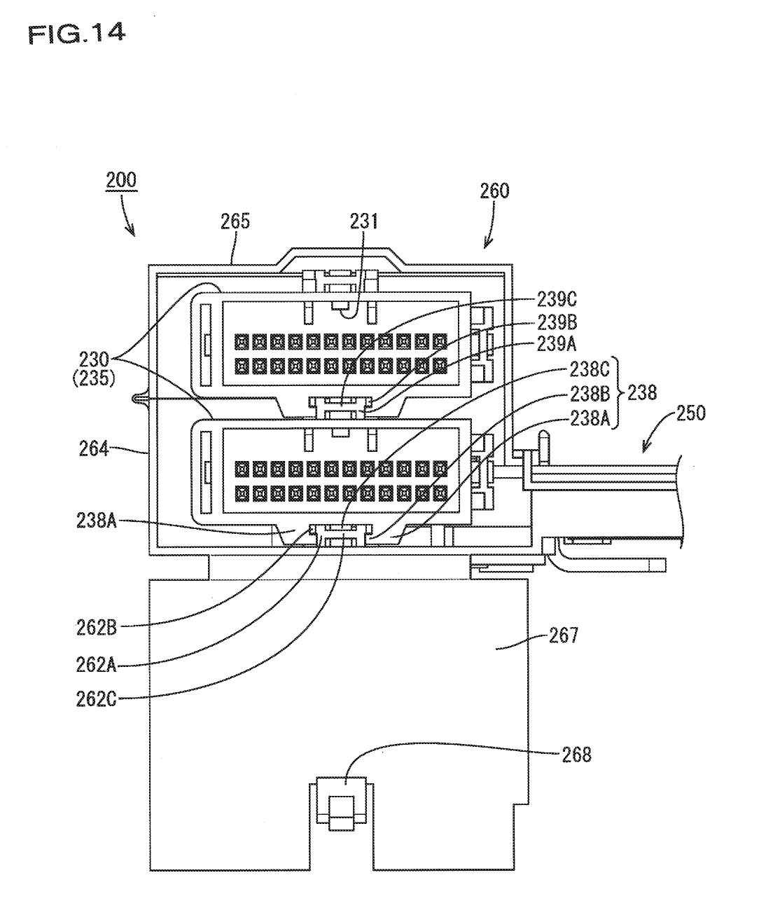

A third embodiment of technology disclosed in the present specification will be described below with reference to FIG. 14.

Whereas the wiring module 1 of the first embodiment has a configuration in which one male connector 30 is housed in the connector housing portion 60, a wiring module 200 of the present embodiment has a configuration in which two male connectors 230 are stacked and housed in a connector housing portion 260. In this case, a pair of leg portions 238A provided on the bottom plate of the male connector 230 on the upper side are locked to the previously described joining portion 39 provided on the top plate of a hood portion 235 of a male connector 231 on the lower side, thus stacking the two male connectors. In other words, the male connector 230 on the upper side is fixed to the insulating protector 40 by the joining portion 39 of the male connector 230 on the lower side.

Note that because a slit is not provided around the joining portion 39, when the male connector 230 on the upper side and the male connector 230 on the lower side are stacked, the lower surface of the male connector 230 on the upper side is moved forward approximately parallel with the upper surface of the male connector 230 on the lower side. At this time, the tapered surface provided at the front surface of the projection portion 238C of the male connector 230 on the upper side moves forward while sliding on the tapered surface provided at the front surface of the step portion 39C of the male connector 230 on the lower side, and therefore can be smoothly moved forward while mitigating interference with the step portion 39C. Other configurations are similar to the first embodiment, and descriptions will not be given for them.

According to the present embodiment, when the number of power storage elements BC that constitute the power storage module BT increases significantly, it is possible to accommodate the increase in number of connector electrodes by stacking multiple male connectors 230, and it is possible to suppress an increase in the amount of used space in the arrangement direction of the power storage elements BC.

Also, according to the present embodiment, the locking leg portions 238 provided on the lower surface of the male connector 230 can be locked to either the connector locking portion 262 provided in the connector housing portion 260 or the joining portion 239 provided on the top plate of another male connector 230, thus making it possible to stack male connectors 230 that have the same structure from the top side to the bottom side.

### Other Embodiments

The technology disclosed in the present specification is not limited to the embodiments described by way of the above descriptions and the drawings, and aspects such as the following can also be carried out, for example.

(1) Although the connector locking portion 62 provided in the connector housing portion 60 is disclosed as a fixing portion in the above embodiments, the fixing portion is not limited in this way. For example, the housing of the male connector 30 may be fixed to the connector support surface 61A with use of a tie band or the like. In other words, any configuration for fixing the housing of the connector to the insulating protector 40 is sufficient, but if possible, it is desirable to be able to be fixed in the connector housing portion 60 at a location near the male connector 30.

(2) Although the detection wires 20 each have one end portion that is connected to a bus bar terminal 10 and detects the voltage of a power storage element BC in the configurations of the embodiments described above, instead of this or in addition, the detection wires 20 may be an electrical wire that is connected to a temperature sensor that detects the temperature of a power element such as a power storage element BC, or in other words need only be an electrical wire for detecting the state of a power element such as a power storage element BC.

(3) Also, the touch prevention lid 67 is not limited to being molded as a single piece with the insulating protector 40 via a hinge, and may be configured as an independent component; also, the touch prevention lid 67 may be provided according to need in view of ensuring safety, and is not necessarily essential.

(4) A slit is not provided around the joining portion 39 of the male connector 30, and the step portion 39C has a front surface that is a tapered surface that decreases in height while extending forward, but the step portion 39C of the male connector 30 is not limited in this way, and, similarly to the connector locking portion 62 provided in the connector housing portion 60, a slit may be provided around the joining portion 39 to obtain a cantilevered shape, and the front surface of the step portion 39C may be made a vertical surface. In other words, a configuration is sufficient in which the joining of male connectors 30 together is not impeded.

### LIST OF REFERENCE NUMERALS

1 Wiring module
20 Detection wire
10 Bus bar terminal (circuit)
30 Male connector (connector)
34 Male terminal
35 Hood portion
36 Opening face
37 Back surface
38 Locking leg portion
39 Joining portion
40 Insulating protector
50 Bus bar support portion
54B Second cover
60 Connector housing portion (wire housing portion, connector support portion)
61 Seat portion
61A Connector support surface
61B Joining surface
62 Connector locking portion (fixing portion)
65 Connector cover
66 Front wire cover
67 Touch prevention lid
69 Fixing member
70 Rear wire cover
F Partner connector

1. A wiring module configured for attachment to a power module in which a plurality of power elements that store or generate electrical power are arranged side-by-side, the wiring module comprising:
an insulating protector that houses a plurality of interconnection conductors for interconnecting the power elements;
a plurality of detection wires that are housed in the insulating protector, extend from a side corresponding to the power elements, and detect a state of the power elements;
a connector that is provided at an end portion of the detection wires and is arranged inside the insulating protector;
an electrical wire housing portion that is provided in the insulating protector and houses the detection wires; and
a connector support portion that includes a fixing portion configured to fix a housing of the connector to the insulating protector.

2. The wiring module according to claim 1,
wherein the connector includes a male terminal,
the housing of the connector includes a hood portion configured to be fitted around a partner housing, and
the connector support portion includes a touch prevention lid configured to block an opening portion of the hood portion.

3. The wiring module according to claim 2,
wherein the touch prevention lid is integrated with the insulating protector via a hinge.

4. The wiring module according to claim 1,
wherein the fixing portion of the connector support portion is provided on one end side of the insulating protector with respect to an arrangement direction of the plurality of power elements, and
the housing of the connector includes a hood portion configured to be fitted around a partner housing, the hood portion being open in a direction orthogonal to the arrangement direction of the plurality of power elements.

5. The wiring module according to claim 1,
wherein a plurality of the housings of the connectors are stacked.
